(19) United States
(12) Patent Application Publication
(10) Pub. No.: US 2009/0241671 A1
(43) Pub. Date: Oct. 1, 2009

(54) Acceleration sensor

(75) Inventor: Akihiko Nomura, Miyazaki (JP)

Correspondence Address: Kubotera & Associates, LLC, 200 Daingerfield Rd, Suite 202, Alexandria, VA, 22314, US

(73) Assignee: Oki Semiconductor Co., Ltd.

(21) Appl. No.: 12/379,954

(22) Filed: Mar. 5, 2009

(30) Foreign Application Priority Data
Mar. 28, 2008 (JP) 2008-085736

(51) Int. Cl. G01P 15/00

(52) U.S. Cl. 73/514.36

(57) ABSTRACT

An acceleration sensor includes a weight portion; a frame portion disposed around the weight portion and away from the weight portion; a beam portion connecting the weight portion and the frame portion; and a stopper portion having a displacement restricting portion for restricting the weight portion from moving upwardly in a vertical direction and a flexible portion connected to the displacement restricting portion and away from the weight portion, the frame portion, and the beam portion.

### BACKGROUND OF THE INVENTION AND RELATED ART STATEMENT

The present invention relates to an acceleration sensor. More specifically, the present invention relates to a semiconductor acceleration sensor capable of performing a reliable operation upon receiving an excessive acceleration.

An acceleration sensor for detecting a three-dimensional acceleration has been widely used in a mobile device such as a cellular phone, a game machine, and a PDV, or in a transportation vehicle such as an automobile, a train, and an aircraft, so that the acceleration sensor detects a state of an object on which the acceleration sensor is mounted. Recently, a size of the mobile device has been rapidly decreasing, thereby making it necessary to reduce a size of the acceleration sensor as well.

A conventional acceleration sensor is produced with MEMS (Micro Electro Mechanical Systems) technology. Patent Reference has disclosed the conventional acceleration sensor. FIG. 11 is a schematic perspective view showing the conventional acceleration sensor.

### Patent Reference: Japanese Patent Publication No. 2004-198243

As shown in FIG. 11, the conventional acceleration sensor includes a base portion 10 to be fixed to an external board and the likes; a weight portion 20; and beam portions 30 having a detection portion for detecting an acceleration and flexibly connecting the weight portion 20 and the base portion 10. Further, the conventional acceleration sensor includes stoppers 40 for restricting a displacement of the weight portion 20, thereby preventing the beam portions 30 from being damaged when the weight portion 20 displaces excessively due to an excessive acceleration.

In the conventional acceleration sensor described above, when the weight portion 20 displaces and hits against the stoppers 4 due to an excessive acceleration, the weight portion 20 may stick to the stoppers 4, thereby causing so-called sticking. When the weight portion 20 sticks to the stoppers 4, it is possible to release the sticking by applying a small acceleration. However, it is difficult to detect an acceleration until applying a small acceleration, thereby lowering reliability of the conventional acceleration sensor in an operation.

In view of the problems described above, an object of the present invention is to provide an acceleration sensor capable of solving the problems of the conventional acceleration sensor. Further, an object of the present invention is to provide a method of producing the acceleration sensor.

Further objects and advantages of the invention will be apparent from the following description of the invention.

### SUMMARY OF THE INVENTION

In order to attain the objects described above, according to an aspect of the present invention, an acceleration sensor includes a weight portion; a frame portion disposed around the weight portion and away from the weight portion; a beam portion connecting the weight portion and the frame portion; and a stopper portion having a displacement restricting portion for restricting the weight portion from moving upwardly in a vertical direction and a flexible portion connected to the displacement restricting portion and away from the weight portion, the frame portion, and the beam portion.

In the aspect of the present invention, the acceleration sensor includes the stopper portion having the flexible portion. Accordingly, even when the weight portion sticks to the stopper portion, the flexible portion quickly applies an impact to the weight portion, thereby making it possible to release the sticking.

### BRIEF DESCRIPTION OF THE DRAWINGS

FIG. 1 is a schematic perspective view showing an acceleration sensor according to a first embodiment of the present invention;

FIG. 2(a) is a schematic sectional view of the acceleration sensor according to the first embodiment of the present invention taken along a line 2(a)-2(a) in FIG. 1, and FIG. 2(b) is a schematic sectional view of the acceleration sensor according to the first embodiment of the present invention taken along a line 2(b)-2(b) in FIG. 1;

FIGS. 3(a) to 3(d) are schematic plan views showing a first substrate, a second substrate, and a third substrate of the acceleration sensor according to the first embodiment of the present invention, wherein FIG. 3(a) is a schematic plan view showing the first substrate of the acceleration sensor according to the first embodiment of the present invention, FIG. 3(b) is a schematic plan view showing the second substrate of the acceleration sensor according to the first embodiment of the present invention, FIG. 3(c) is a schematic plan view showing the third substrate of the acceleration sensor according to the first embodiment of the present invention, and FIG. 3(d) is a schematic enlarged view showing a portion D shown in FIG. 3(c);

FIGS. 4(a) to 4(d) are schematic sectional views showing an operation of the acceleration sensor according to the first embodiment of the present invention;

FIGS. 5(a) to 5(e) are schematic sectional views showing a method of producing the acceleration sensor according to the first embodiment of the present invention;

FIG. 6 is a schematic plan view showing an acceleration sensor according to a second embodiment of the present invention;

FIGS. 7(a) and 7(b) are schematic plan views showing an acceleration sensor according to a third embodiment of the present invention;

FIG. 8 is a schematic plan view showing an acceleration sensor according to a fourth embodiment of the present invention;

FIGS. 9(a) and 9(b) are schematic plan views showing an acceleration sensor according to a fifth embodiment of the present invention;

FIGS. 10(a) and 10(b) are schematic plan views showing an acceleration sensor according to a sixth embodiment of the present invention; and

FIG. 11 is a schematic perspective view showing a conventional acceleration sensor.

### DETAILED DESCRIPTION OF PREFERRED EMBODIMENTS

Hereunder, embodiments of the present invention will be explained with reference to the accompanying drawings.

### First Embodiment

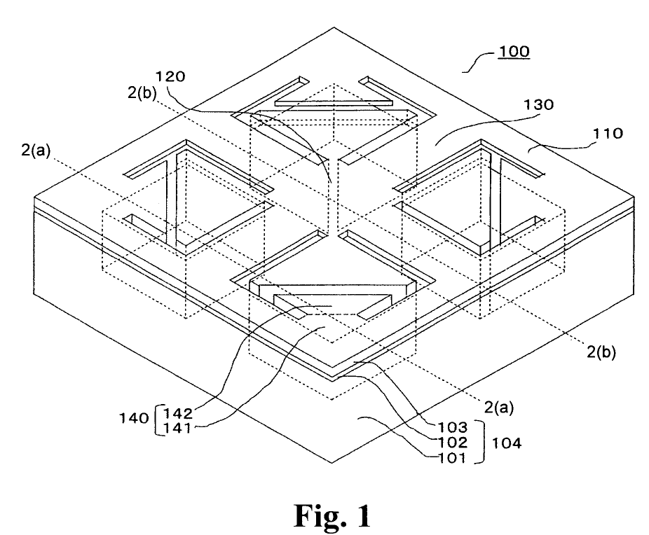

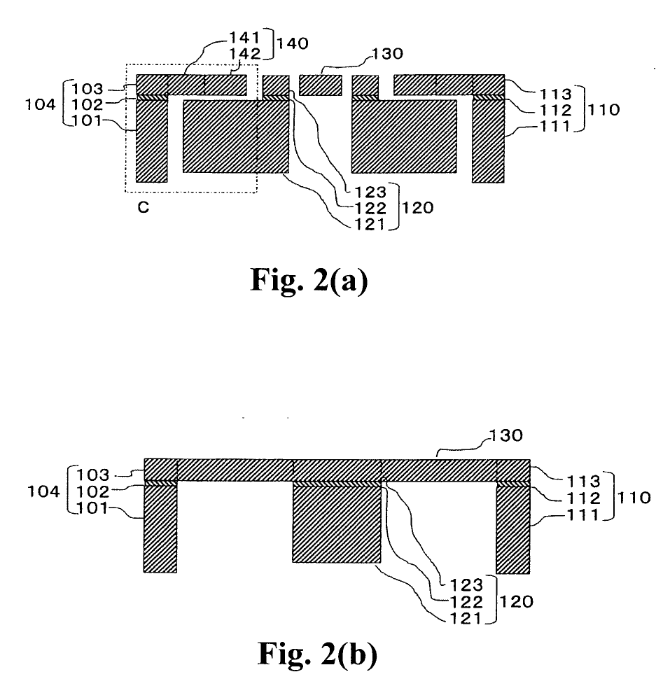

A first embodiment of the present invention will be explained. FIG. 1 is a schematic perspective view showing an acceleration sensor 100 according to the first embodiment of the present invention. FIG. 2(a) is a schematic sectional view of the acceleration sensor 100 according to the first embodiment of the present invention taken along a line 2(a)-2(a) in FIG. 1. FIG. 2(b) is a schematic sectional view of the acceleration sensor 100 according to the first embodiment of the present invention taken along a line 2(b)-2(b) in FIG. 1.

As shown in FIG. 1, the acceleration sensor 100 is formed of a laminated substrate 104 having three layers, in which a first substrate 101, a second substrate 102, and a third substrate 103 are laminated in this order such that an upper surface of each substrate faces in a same direction. Further, the acceleration sensor 100 includes a frame portion 110, a weight portion 120, beam portions 130, and stopper portions 140.

As shown in FIGS. 2(a) and 2(b), the frame portion 110 includes a first frame portion 111 formed in the first substrate 101; a second frame portion 112 formed in the second substrate 102; and a third frame portion 113 formed in the third substrate 103. As shown in FIG. 1 and FIGS. 2(a) and 2(b), the frame portion 110 has through holes extending between an upper surface and a lower surface of the laminated substrate 104 having a square shape. Further, the third frame portion 113, i.e., an uppermost layer of the frame portion 110, is connected to the beam portions 130 and the stopper portions 140 (described later).

As shown in FIGS. 2(a) and 2(b), the weight portion 120 includes a first weight portion 121 formed in the first substrate 101; a second weight portion 122 formed in the second substrate 102; and a third weight portion 123 formed in the third substrate 103. Further, the weight portion 120 is connected to the beam portions 130 (described later).

In the embodiment, as shown in FIG. 2(b), each of the beam portions 130 is formed in the third substrate 103, and has a shape having one end portion connected to the third frame portion 113 of the frame portion 110 and the other end portion connected to the third weight portion 123 of the weight portion 120. Further, the beam portions 130 have flexibility, and a strain detection element (not shown) is formed on the beam portions 130 for detecting a strain of the beam portions 130 when the beam portions 130 deform due to an acceleration.

As shown in FIG. 1 and FIG. 2(a), the stopper portions 140 are formed in the third substrate 103. Further, the stopper portions 140 are situated away from the weight portion 120 and the beam portions 130, and connected to the third frame portion 113 of the frame portion 110. Each of the stopper portions 140 includes a displacement restricting portion 141 and a flexible portion 142 connected to the displacement restricting portion 141. The displacement restricting portion 141 covers the first weight portion 121 of the weight portion 120, and is situated away from the first weight portion 121 of the weight portion 120, so that the displacement restricting portion 141 restricts a displacement of the weight portion 120. The flexible portion 142 has flexibility to deform according to an acceleration or an impact of the weight portion 120 applied to the displacement restricting portion 141, so that the flexible portion 142 applies an impact to the weight portion 120 through a reaction force thereof.

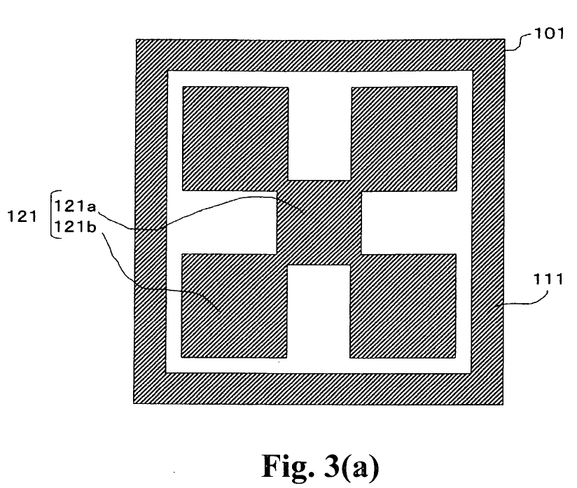

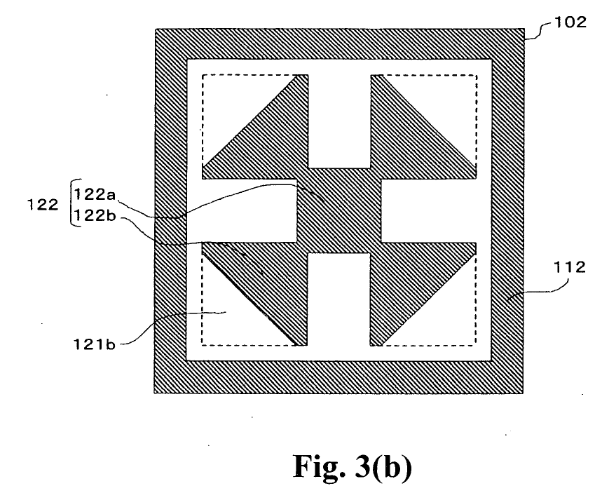

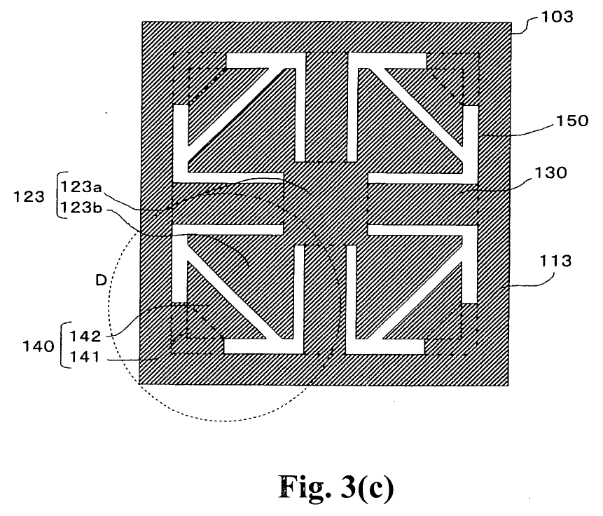

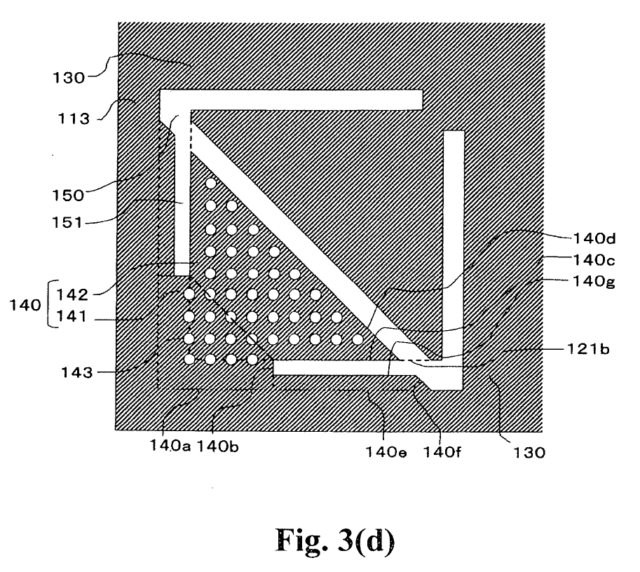

FIGS. 3(a) to 3(d) are schematic plan views showing the first substrate 101, the second substrate 102, and the third substrate 103 of the acceleration sensor 100 according to the first embodiment of the present invention. More specifically, FIG. 3(a) is a schematic plan view showing the first substrate 101 of the acceleration sensor 100 according to the first embodiment of the present invention; FIG. 3(b) is a schematic plan view showing the second substrate 102 of the acceleration sensor 100 according to the first embodiment of the present invention; FIG. 3(c) is a schematic plan view showing the third substrate 103 of the acceleration sensor 100 according to the first embodiment of the present invention; and FIG. 3(d) is a schematic enlarged view showing a portion D shown in FIG. 3(c). In FIGS. 3(b) and 3(c), the first substrate 101 and the second substrate 102 are situated under the third substrate 103, and represented with hidden lines.

As shown in FIG. 3(a), the first frame portion 111 and the first weight portion 121 are formed in the first substrate 101 of the acceleration sensor 100. In the embodiment, the first substrate 101 is formed of a silicon substrate, and has a thickness of 300 to 400 μm. The first frame portion 111 has a rectangular shape with a through hole formed therein at a center thereof, and an outer frame of the first frame portion 111 has a square shape having a side length of 1.5 to 2.0 mm. Further, the first frame portion 111 has a width of 150 to 200 μm.

In the embodiment, the first weight portion 121 of the acceleration sensor 100 is disposed inside the first frame portion 111 and away from the first frame portion 111. The first weight portion 121 includes a center weight portion 121a and surrounding weight portions 121b. The center weight portion 121a is situated inside the first frame portion 111 at the center thereof, and has a rectangular shape having a side length of 220 to 270 μm. The surrounding weight portions 121b are situated at four corners of the center weight portion 121a, and have an identical rectangular shape having a side length of 450 to 500μm. The surrounding weight portions 121b are situated away from an inner wall of the first frame portion 111 by a distance of 40 to 50μm.

As shown in FIG. 3(b), the second frame portion 112 and the second weight portion 122 are formed in the second substrate 102 of the acceleration sensor 100. In the embodiment, the second substrate 102 is formed of a silicon oxide film, and has a thickness of 1 to 3μm. The second frame portion 112 has a shape the same as that of the first frame portion 111, and is disposed on the first frame portion 111. Further, the second weight portion 122 includes a center weight portion 122a and surrounding weight portions 122b. The center weight portion 122a of the second weight portion 122 has a shape the same as that of the center weight portion 121a of the first weight portion 121, and is disposed on the center weight portion 121a of the first weight portion 121.

In the embodiment, the surrounding weight portions 122b of the second weight portion 122 are disposed on the surrounding weight portions 121b of the first weight portion 121. The surrounding weight portions 122b of the second weight portion 122 have a shape different from that of the surrounding weight portions 121b of the first weight portion 121. More specifically, the surrounding weight portions 122b of the second weight portion 122 have a triangular shape or a pentagonal shape, in which a square shape has one corner portion opposite to a corner thereof connected to the center weight portion 121a retracting toward the corner thus connected.

In this case, when the one corner retracts beyond corners adjacent to the corner thus connected, the surrounding weight portions 122b of the second weight portion 122 have a triangular shape. When the one corner does not retract beyond the corners adjacent to the corner thus connected, the surrounding weight portions 122b of the second weight portion 122 have a pentagonal shape.

In the embodiment, when the surrounding weight portions 122b of the second weight portion 122 have a triangular shape, it is possible to increase an area of the stopper portions 140, thereby improving impact resistance of the acceleration sensor 100. When the surrounding weight portions 122b of the second weight portion 122 have a pentagonal shape, it is possible to increase a weight of the weight portion 120, thereby improving detection sensitivity of the acceleration sensor 100. As shown in FIG. 3(b), in the acceleration sensor 100 in the embodiment, the one corner retracts near the corners adjacent to the corner thus connected, so that the surrounding weight portions 122b of the second weight portion 122 have a pentagonal shape.

As shown in FIG. 3(c), the third frame portion 113, the third weight portion 123, the beam portions 130, and the stopper portions 140 are formed in the third substrate 103 of the acceleration sensor 100. Note that groove portions 150 are formed in the third substrate 103, so that the third frame portion 113, the third weight portion 123, the beam portions 130, and the stopper portions 140 are integrally formed in the third substrate 103.

In the following description, the third frame portion 113, the third weight portion 123, the beam portions 130, and the stopper portions 140 will be explained as independent portions having independent functions. Accordingly, the third frame portion 113, the third weight portion 123, the beam portions 130, and the stopper portions 140 are shown in FIG. 3(c) with projected lines in between as boundaries.

In the embodiment, the third substrate 103 is formed of a silicon substrate, and has a thickness of 5 to 10μm. The third frame portion 113 has a shape the same as that of the first frame portion 111 and the second frame portion 112, and is disposed on the second frame portion 112. The third weight portion 123 includes a center weight portion 123a and surrounding weight portions 123b. The center weight portion 123a of the third weight portion 123 has a shape the same as that of the center weight portion 121a of the first weight portion 121 and the center weight portion 122a of the second weight portion 122, is disposed on the center weight portion 122a of the second weight portion 122. The surrounding weight portions 123b of the third weight portion 123 have a shape the same as that of the surrounding weight portions 122b of the second weight portion 122, and are disposed on the surrounding weight portions 122b of the second weight portion 122.

In the embodiment, the beam portions 130 are connected to the third frame portion 113 and the third weight portion 123. More specifically, one end portion of each of the beam portions 130 is connected to one of four sides defining an inner wall of the third frame portion 113 at a center portion thereof. The other end portion of each of the beam portions 130 is connected to one of four sides of the center weight portion 123a of the third weight portion 123 at a center portion thereof facing the one of the four sides of the third frame portion 113 connected to the one end portion of each of the beam portions 130.

In the embodiment, the stopper portions 140 are connected to the third frame portion 113, and include the displacement regulating portions 141 and the flexible portions 142. Each of the stopper portions 140 is disposed at each of upper four corners of the acceleration sensor 100 to cover each of the weight portions 121b of the first weight portion 121. Further, each of the stopper portions 140 extends from each of the upper four corners toward an opposite corner.

The stopper portions 140 will be explained in more detail with reference to FIG. 3(d). FIG. 3(d) is a schematic enlarged view showing a portion D shown in FIG. 3(c), i.e., one of the stopper portions 140 and a surrounding portion thereof.

As shown in FIG. 3(d), the stopper portion 140 is disposed in an area surrounded with the third frame portion 113, the third weight portion 123 of the weight portion 120, and the beam portions 130. As described above, the stopper portion 140 includes the displacement regulating portion 141 and the flexible portion 142.

In the embodiment, an upper surface of the stopper portion 140 is defined with first lines 140a, second lines 140b, third lines 140c, and a fourth line 140d. The first lines 140a extend from a corner of the third frame portion 113 between the beam portions 130 adjacent to each other toward the beam portions 130. The second lines 140b extend from ends of the first lines near the beam portions 130 and away from the third frame portion 113. The third lines 140c extend from ends of the second lines 140b away from the third frame portion 113 toward the beam portions 130 along the third frame portion 113. The fourth line 140d connects ends of the third lines 140c on a side of the beam portions 130.

When viewed from above, the third lines 140c are situated at positions aligned with outer edges of the surrounding weight portions 121b of the first weight portion 121. The displacement regulating portion 141 is defined with the first lines 140a and the second lines 140b. The flexible portion 142 is defined with the third lines 140c and the fourth line 140d.

In the embodiment, the stopper portion 140 may have a shape additionally including a portion defined with fifth lines 140e, sixth lines 140f, and seventh lines 140g. The fifth lines 140e extend from the first lines 140a toward the beam portions 130. The sixth lines 140f extend from ends of the fifth lines 140e on a side of the beam portions 130 and away from the third frame portion 113. The seventh lines 140g connect ends of the sixth lines 140f away from the third frame portion 113 and the second lines 140b. In this case, ends of the second lines 140b are connected to the seventh lines 140g, not to the first lines 140a.

In the embodiment, groove sections 151 are defined with the second lines 140b, the third lines 140c, and the fifth lines 140e or the seventh lines 140g to from the groove portions 150. In this case, the third lines 140c may not be situated at positions aligned with outer edges of the surrounding weight portions 121b of the first weight portion 121. Further, the fifth lines 140e or the seventh lines 140g may not be situated at positions aligned with inner walls of the third frame portion 113.

When the groove sections 151 of the groove portions 150 defined with the second lines 140b, the third lines 140c, and the fifth lines 140e or the seventh lines 140g are situated at positions between the surrounding weight portions 121b and the third frame portion 113, it is possible to form the stopper portion 140 including the flexible portion 142 connected to the displacement regulating portion 141.

In the embodiment, the displacement regulating portion 141 is defined with the first lines 140a and the second lines 140b, and is connected to the third frame portion 113. Further, the displacement regulating portion 141 is disposed at a position away from the surrounding weight portion 121b of the first weight portion 121 to cover the same. The displacement regulating portion 141 of the stopper portion 140 has an impact resistant property for restricting a displacement of the weight portion 120 in a vertical direction.

In the embodiment, the flexible portion 142 is defined with the third lines 140c and the fourth line 140d, and is connected to the displacement regulating portion 141. Further, the flexible portion 142 is disposed at a position away from the frame portion 110, the weight portion 120, and the beam portions 130 to cover the surrounding weight portion 121b of the first weight portion 121. The flexible portion 142 of the stopper 140 has flexibility in a vertical direction according to an acceleration or an impact applied from the weight portion 120 to the stopper portion 140. It is preferred that the flexible portion 142 has an area larger than that of the displacement regulating portion 141, thereby improving a sticking prevention effect (described later).

In the embodiment, the stopper 140 has a triangular shape disposed at the corner of the third frame portion 113 viewed from above. The groove sections 151 are formed to divide a longest side of the rectangular shape and extend toward the corner of the third frame portion 113. Further, the groove sections 151 are formed at positions not overlapping with the weight portion 120. With the groove sections 151, the stopper portion 140 with the triangular shape is divided into the portions having two different functions, i.e., the displacement regulating portion 141 for restricting a displacement of the weight portion 120 and the flexible portion 142 with flexibility having an end portion away from the third frame portion 113 with the groove sections 151.

As shown in FIG. 3(d), the groove sections 151 extend toward the corner of the third frame portion 113 along an edge of the weight portion 120 viewed from above. More specifically, in the acceleration sensor 100, the groove sections 151 extend over a length corresponding to 40% to 50% of a length of the stopper portion 140 connected to the frame portion 110.

In the embodiment, the length of the stopper portion 140 connected to the frame portion 110 is between 300μm to 350μm. The length of the groove sections 151 is between 120μm to 180μm, and a width of the groove sections 151 is between 10μm to 15μm. Note that the groove sections 151 are not necessarily aligned with the edge of the weight portion 120 viewed from above, and it is suffice that the groove sections 151 are situated between the weight portion 120 and the frame portion 110.

As shown in FIG. 3(d), the stopper portions 140 has a plurality of opening portions 143 over the displacement regulating portion 141 and the flexible portion 142. When the acceleration sensor 100 is produced, the opening portions 143 are provided for facilitating removal of the first weight portion 121 to separate the stopper portion 140 from the first weight portion 121.

In the embodiment, the opening portions 143 may be formed in a mesh pattern over an entire surface of the stopper portion 140, or may be arranged such that a distance between an outer edge of the stopper portion 140 and the opening portion 143 or a distance between the opening portions 143 becomes less than, for example, 5μm to 10μm. When the opening portions 143 are formed near a boundary between the displacement regulating portion 141 and the flexible portion 142 at a higher density, it is possible to flexibly deform the flexible portion 142 more easily. Accordingly, it is possible to enhance the sticking prevention effect (described later) in addition to the effect of facilitating the removal of the first weight portion 121.

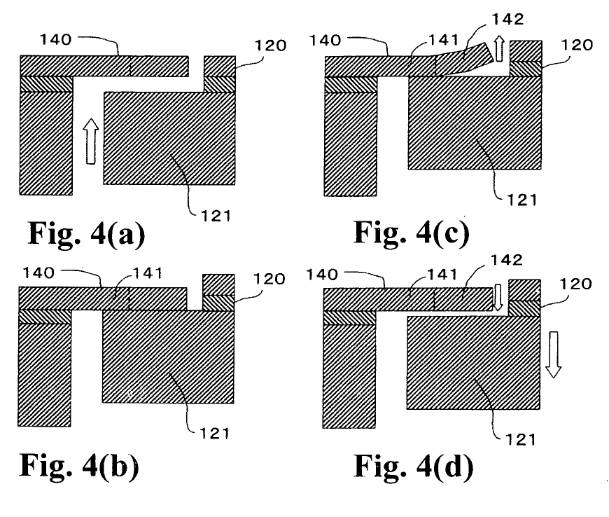

An operation of the acceleration sensor 100 will be explained next. FIGS. 4(a) to 4(d) are schematic sectional views showing the operation of the acceleration sensor 100 according to the first embodiment of the present invention. FIGS. 4(a) to 4(d) are schematic enlarged sectional views corresponding to a portion C shown in FIG. 2(a). Arrows in FIGS. 4(a) to 4(d) represent directions that the weight portion 120 and the flexible portion 142 move.

FIG. 4(a) is the schematic sectional view showing a state that an acceleration is applied to the acceleration sensor 100 to move or displace the weight portion 120 upwardly. Accordingly, the weight portion 120 moves upwardly, so that the first weight portion 121 of the weight portion 120 approaches the stopper portion 140.

FIG. 4(b) is the schematic sectional view continued from FIG. 4(a) and showing a state that the weight portion 120 contacts with the stopper portion 140. More specifically, the acceleration is applied to the acceleration sensor 100 to move or displace the weight portion 120 upwardly, and the first weight portion 121 of the weight portion 120 contacts with the stopper portion 140. At this moment, the displacement regulating portion 141 restricts the displacement of the weight portion 120, so that the weight portion 120 does not move upwardly any further.

FIG. 4(c) is the schematic sectional view continued from FIG. 4(b) and showing a state that the first weight portion 121 of the weight portion 120 temporarily sticks to the displacement regulating portion 141 of the stopper portion 140. Further, as shown in FIG. 4(c), the weight portion 120 moves upwardly and hits the stopper portion 140, so that the flexible portion. 142 deforms upwardly. At this moment, before the weight portion 120 moves upwardly and hits the stopper portion 140, if the flexible portion 142 sags toward the first substrate 101 with an own weight, the flexible portion 142 can deform upwardly to a larger extent.

FIG. 4(d) is the schematic sectional view continued from FIG. 4(c) and showing a state that the flexible portion 142 deforms downwardly after the weight portion 120 hits the stopper portion 140 and the flexible portion 142 deforms upwardly. When the flexible portion 142 deforms downwardly, the flexible portion 142 hits the first weight portion 121 of the weight portion 120, so that the weight portion 120 moves downwardly. Accordingly, even when the first weight portion 121 of the weight portion 120 sticks to the displacement regulating portion 141 of the stopper portion 140, the first weight portion 121 is detached from the displacement regulating portion 141 as the flexible portion 142 hits the first weight portion 121.

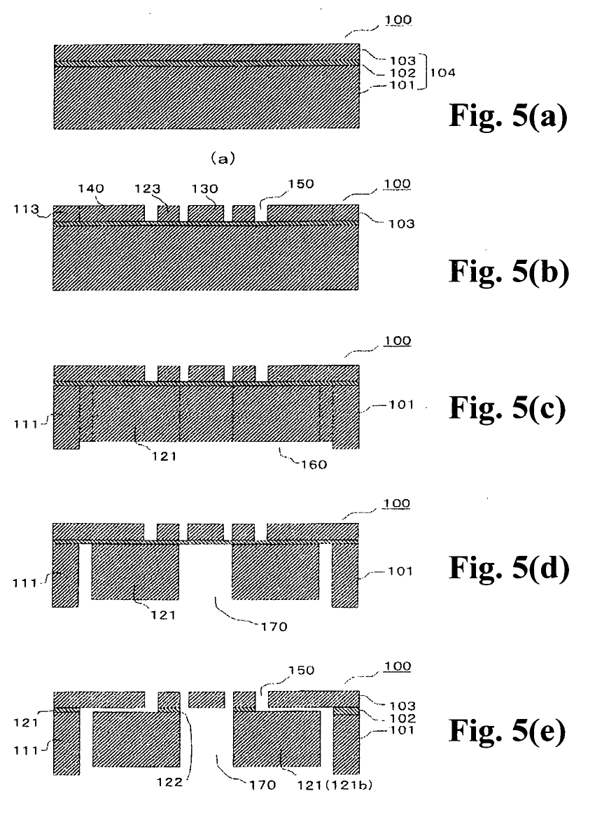

A method of producing the acceleration sensor 100 will be explained next. FIGS. 5(a) to 5(e) are schematic sectional views showing the method of producing the acceleration sensor 100 according to the first embodiment of the present invention. FIGS. 5(a) to 5(e) are the schematic sectional views corresponding to FIG. 2(a).

As shown in FIG. 5(a), the first substrate 101, the second substrate 102, and the third substrate 103 are laminated to form a laminated substrate 104 (an SOI substrate). As described above, the first substrate 101 and the third substrate 103 are formed of silicon, and the second substrate 102 is formed of the silicon oxide film. Accordingly, the second substrate 102 functions as an etching stopper layer with respect to the first substrate 101 and the third substrate 103, thereby making it easy to produce the acceleration sensor 100 as opposed to a single substrate or a laminated substrate formed of a single material. Note that the first substrate 101, the second substrate 102, and the third substrate 103 have the upper surfaces and the lower surfaces, respectively, and are laminated such that the upper surfaces thereof face toward a same direction.

In the next step, as shown in FIG. 5(b), a piezo resistor element (not shown) is formed in the third substrate 103 through a semiconductor circuit manufacturing process, so that the piezo resistor element is disposed on the beam portion 130. Then, the groove portions 150 are formed in the third substrate 103, so that the third substrate 103 has the upper surface shown in FIG. 3(c). More specifically, the groove portions 150 are formed through anisotropy etching to define the third frame portion 113, the third weight portion 123, the beam portions 130, and the stopper portions 140. At the same time, the opening portions 143 are formed in the stopper portions 140.

In the next step, as shown in FIG. 5(c), a recess portion 160 is formed in the lower surface of the first substrate 101. The recess portion 160 has a depth of 8 to 15μm, so that the first weight portion 121 has a thickness smaller than that of the first frame portion 111. Accordingly, a portion of the recess portion 160 formed in the first substrate 101 becomes a bottom surface of the first weight portion 121, and a portion of the first substrate 101 without the recess portion 160 becomes a bottom surface of the first frame portion 111. When a mounting member having a recess portion just below the weight portion 120, it is possible to omit the step. When such a mounting member is used, the weight portion 120 can displace downwardly without the recess portion 160 upon mounting the acceleration sensor 100.

In the next step, as shown in FIG. 5(d), second groove portions 170 are formed, so that the first substrate 101 has the upper surface shown in FIG. 3(a). More specifically, the second groove portions 170 are formed through anisotropy etching to define the first frame portion 111 and the first weight portion 121.

In the next step, a portion of the second substrate 102 is removed to form the second frame portion 112 and the second weight portion 122. More specifically, when the second substrate 102 is etched through wet etching, an etchant reaches the second substrate 102 through the groove portions 150 of the third substrate 103, the opening portions 143 formed in the stopper portions 140, and the second groove portions 170 of the first substrate 101, so that the portion of the second substrate 102 is removed in an isotropic manner through etching, thereby forming the second frame portion 112 and the second weight portion 122.

In this step, with the opening portions 143 formed in the stopper portions 140, it is possible to effectively remove the second substrate 102 between the stopper portions 140 and the surrounding weight portions 121b of the first weight portion 121, thereby reducing an etching time. After the steps described above are completed, the laminated substrate 104 is cut into individual pieces, thereby obtaining the acceleration sensor 100. Through the process described above, it is possible to produce the acceleration sensor 100.

### Second Embodiment

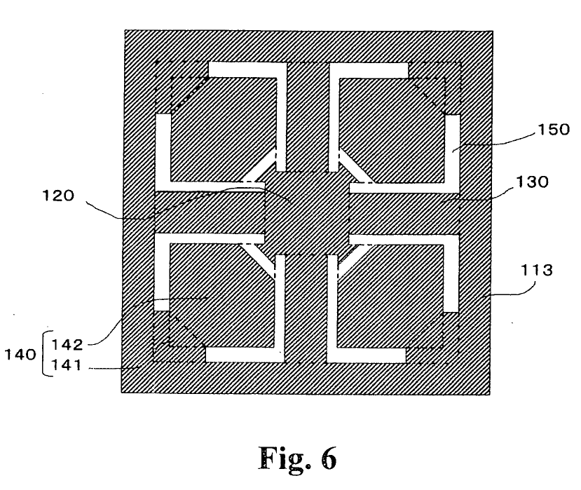

A second embodiment of the present invention will be explained next. FIG. 6 is a schematic plan view showing the acceleration sensor 100 according to the second embodiment of the present invention.

In the second embodiment, the third substrate 103 has a shape different from that of the third substrate 103 in the first embodiment, and the first substrate 101 and the second substrate 102 have shapes the same as those of the first substrate 101 and the second substrate 102 in the first embodiment. More specifically, the third substrate 103 in the second embodiment is formed of a material the same as that of the third substrate 103 in the first embodiment, and has a thickness the same as that of the third substrate 103 in the first embodiment. The groove portions 150 in the second embodiment have a shape different from that of the groove portions 150 in the first embodiment.

In the second embodiment, similar to the first embodiment, the third frame portion 113, the third weight portion 123, and the beam portions 130 are integrally formed in the third substrate 103 with the groove portions 150, and boundaries therebetween are represented with projected lines for an explanation purpose. Further, the first substrate 101 and the second substrate 102 under the third substrate 103 are represented with hidden lines.

As shown in FIG. 6, as compared with the acceleration sensor 100 in the first embodiment, the groove portions 150 are situated at different locations between the third weight portion 123 and the flexible portions 142. More specifically, in the acceleration sensor 100 in the first embodiment, end portions of the stopper portions 140 do not extend beyond imaginary lines between connected portions of two adjacent beam portions 130 and the third frame portion 113. On the other hand, in the acceleration sensor 100 in the second embodiment, the end portions of the stopper portions 140 extend beyond the imaginary lines, thereby increasing a volume of the flexible portions 142. Accordingly, the flexible portions 142 apply a larger impact on the weight portion 120 upon sticking, thereby improving the sticking prevention effect.

### Third Embodiment

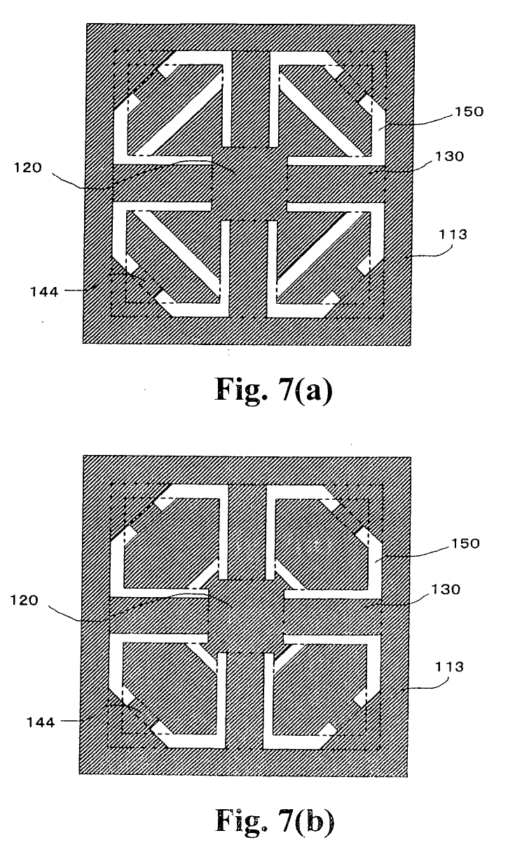

A third embodiment of the present invention will be explained next. FIGS. 7(a) and 7(b) are schematic plan views showing the acceleration sensor 100 according to the third embodiment of the present invention.

In the third embodiment, the third substrate 103 has a shape different from that of the third substrate 103 in the first embodiment, and the first substrate 101 and the second substrate 102 have shapes the same as those of the first substrate 101 and the second substrate 102 in the first embodiment. More specifically, the third substrate 103 in the third embodiment is formed of a material the same as that of the third substrate 103 in the first embodiment, and has a thickness the same as that of the third substrate 103 in the first embodiment. The groove portions 150 in the third embodiment have a shape different from that of the groove portions 150 in the first embodiment.

In the third embodiment, similar to the first embodiment, the third frame portion 113, the third weight portion 123, and the beam portions 130 are integrally formed in the third substrate 103 with the groove portions 150, and boundaries therebetween are represented with projected lines for an explanation purpose. Further, the first substrate 101 and the second substrate 102 under the third substrate 103 are represented with hidden lines.

As shown in FIG. 7(a), as compared with the acceleration sensor 100 in the first embodiment, connecting portions 144 are disposed between the displacement restricting portions 141 and the flexible portions 142. The connecting portions 144 have a width smaller than that of the beam portions 130. When the connecting portions 144 are disposed between the displacement restricting portions 141 and the flexible portions 142, the flexible portions 142 deform more easily. Accordingly, when the weight portion 120 sticks to the stopper portions 140, it is possible to apply a larger impact.

FIG. 7(b) is the schematic sectional view showing a modified example of the acceleration sensor 100 according to the third embodiment of the present invention. As shown in FIG. 7(b), as compared with the acceleration sensor 100 shown in FIG. 7(a), the groove portions 150 are situated at different locations between the third weight portion 123 and the flexible portions 142. More specifically, in the acceleration sensor 100 shown in FIG. 7(a), the end portions of the stopper portions 140 do not extend beyond the imaginary lines between the connected portions of two adjacent beam portions 130 and the third frame portion 113. On the other hand, in the acceleration sensor 100 shown in FIG. 7(b), the end portions of the stopper portions 140 extend beyond the imaginary lines, thereby increasing a volume of the flexible portions 142. When the connecting portions 144 with the width smaller than that of the beam portions 130 are provided, and the volume of the flexible portions 142 increases, the flexible portions 142 apply a larger impact on the weight portion 120 upon sticking.

### Fourth Embodiment

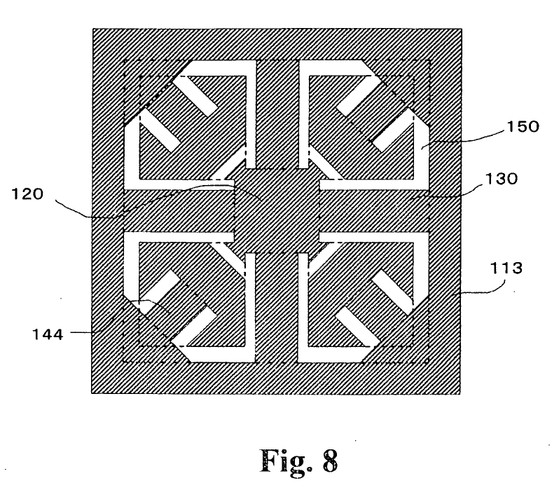

A fourth embodiment of the present invention will be explained next. FIG. 8 is a schematic plan view showing the acceleration sensor 100 according to the fourth embodiment of the present invention.

In the fourth embodiment, the third substrate 103 has a shape different from that of the third substrate 103 in the first embodiment, and the first substrate 101 and the second substrate 102 have shapes the same as those of the first substrate 101 and the second substrate 102 in the first embodiment. More specifically, the third substrate 103 in the fourth embodiment is formed of a material the same as that of the third substrate 103 in the first embodiment, and has a thickness the same as that of the third substrate 103 in the first embodiment. The groove portions 150 in the fourth embodiment have a shape different from that of the groove portions 150 in the first embodiment.

In the fourth embodiment, similar to the first embodiment, the third frame portion 113, the third weight portion 123, and the beam portions 130 are integrally formed in the third substrate 103 with the groove portions 150, and boundaries therebetween are represented with projected lines for an explanation purpose. Further, the first substrate 101 and the second substrate 102 under the third substrate 103 are represented with hidden lines.

As shown in FIG. 8, as compared with the acceleration sensor 100 shown in FIG. 7(a), the connecting portions 144 extend near the imaginary lines, and the flexible portions 142 are disposed surrounding and away from the connecting portions 144. When the displacement restricting portions 141 are away from the flexible portions 142 by a larger distance, the flexible portions 142 deform more easily. Accordingly, when the weight portion 120 sticks to the stopper portions 140, it is possible to apply a larger impact.

### Fifth Embodiment

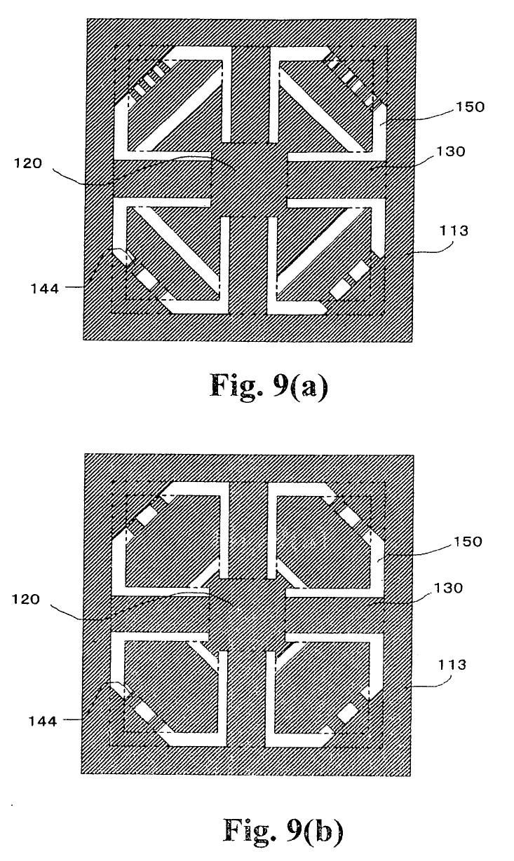

A fifth embodiment of the present invention will be explained next. FIGS. 9(a) and 9(b) are schematic plan views showing the acceleration sensor 100 according to the fifth embodiment of the present invention.

In the fifth embodiment, the third substrate 103 has a shape different from that of the third substrate 103 in the first embodiment, and the first substrate 101 and the second substrate 102 have shapes the same as those of the first substrate 101 and the second substrate 102 in the first embodiment. More specifically, the third substrate 103 in the fifth embodiment is formed of a material the same as that of the third substrate 103 in the first embodiment, and has a thickness the same as that of the third substrate 103 in the first embodiment. The groove portions 150 in the fifth embodiment have a shape different from that of the groove portions 150 in the first embodiment.

In the fifth embodiment, similar to the first embodiment, the third frame portion 113, the third weight portion 123, and the beam portions 130 are integrally formed in the third substrate 103 with the groove portions 150, and boundaries therebetween are represented with projected lines for an explanation purpose. Further, the first substrate 101 and the second substrate 102 under the third substrate 103 are represented with hidden lines.

As shown in FIG. 9(a), in the acceleration sensor 100 in the fifth embodiment, each of the connecting portions 144 shown in FIG. 7(a) is divided into a plurality of the connecting portions 144. More specifically, as compared with the acceleration sensor 100 shown in FIG. 7(a), the displacement restricting portions 141 are connected to the flexible portions 142 over an entire width thereof. Accordingly, even when the flexible portions 142 are twisted relative to the displacement restricting portions 141, it is possible to prevent the flexible portions 142 from being damaged.

In the fifth embodiment, it is preferred that a total sum of widths of the connecting portions 144 divided into plural portions is less than the width of the beam portions 130. Accordingly, the flexible portions 142 deform more easily. With the configuration described above, the stopper portions 140 are separated from the first weight portion 121. Accordingly, when the second substrate 102 is removed, it is possible to remove the second substrate 102 more efficiently. In the acceleration sensor 100 shown in FIG. 9(a), each of the stopper portions 140 has the connecting portions 144 in a different number just as an example. In an actual case, each of the stopper portions 140 may have the connecting portions 144 in a same number.

FIG. 9(b) is the schematic sectional view showing a modified example of the acceleration sensor 100 according to the fifth embodiment of the present invention. As shown in FIG. 9(b), as compared with the acceleration sensor 100 shown in FIG. 7(b), each of the connecting portions 144 is divided into a plurality of the connecting portions 144. Accordingly, in addition to the effect of the acceleration sensor 100 shown in FIG. 7(b), it is possible to obtain the effect of the flexible portions 142 having a larger volume.

### Sixth Embodiment

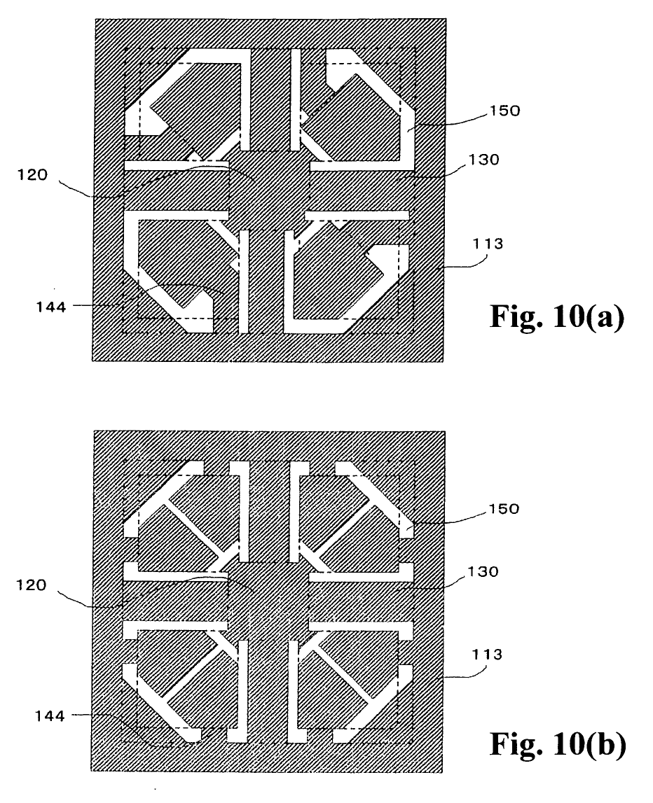

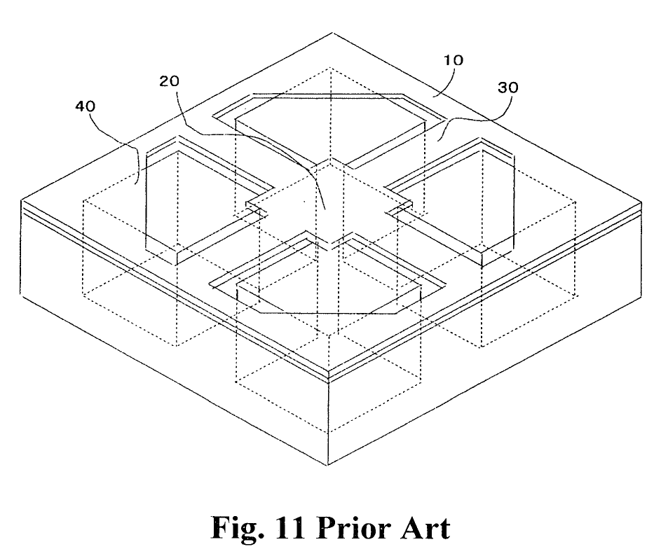

A sixth embodiment of the present invention will be explained next. FIGS. 10(a) and 10(b) are schematic plan views showing the acceleration sensor 100 according to the sixth embodiment of the present invention.

In the sixth embodiment, the third substrate 103 has a shape different from that of the third substrate 103 in the first embodiment, and the first substrate 101 and the second substrate 102 have shapes the same as those of the first substrate 101 and the second substrate 102 in the first embodiment. More specifically, the third substrate 103 in the sixth embodiment is formed of a material the same as that of the third substrate 103 in the first embodiment, and has a thickness the same as that of the third substrate 103 in the first embodiment. The groove portions 150 in the sixth embodiment have a shape different from that of the groove portions 150 in the first embodiment.

In the sixth embodiment, similar to the first embodiment, the third frame portion 113, the third weight portion 123, and the beam portions 130 are integrally formed in the third substrate 103 with the groove portions 150, and boundaries therebetween are represented with projected lines for an explanation purpose. Further, the first substrate 101 and the second substrate 102 under the third substrate 103 are represented with hidden lines.

As shown in FIG. 10(a), as compared with the acceleration sensor 100 in the first embodiment, the flexible portions 142 are not connected to the displacement restricting portions 141. More specifically, the flexible portions 142 and the displacement restricting portions 141 are provided separately, and the flexible portions 142 are connected to the third frame portion 113 through the connecting portions 144.

FIG. 10(b) is the schematic sectional view showing a modified example of the acceleration sensor 100 according to the sixth embodiment of the present invention. As shown in FIG. 10(b), similar to the acceleration sensor 100 shown in FIG. 10(a), the flexible portions 142 are connected to the third frame portion 113, not to the displacement restricting portions 141, through the connecting portions 144. Further, each of the flexible portions 142 is divided into two portions, and the two portions are connected to different sides of the third frame portion 113 through the connecting portions 144.

In the sixth embodiment, it is preferred that a total sum of areas of the flexible portions 142 is larger than that of the displacement restricting portions 141, thereby improving impact resistance. As described above, the flexible portions 142 and the displacement restricting portions 141 are provided separately. Accordingly, even when one of the stopper portions 140 is broken, the other of the stopper portions 140 applies an impact to the weight portion 120, thereby releasing the sticking.

In the embodiments described above, it may be configured such that the acceleration sensor includes the laminated substrate including the first substrate, the second substrate formed on the first substrate, and the third substrate formed on the second substrate. The first substrate includes the first groove portion for separating the first weight portion constituting the weight portion and the first frame portion surrounding away from the first weight portion and constituting the frame portion. The second substrate includes the second groove portion for separating the second weight portion constituting the weight portion and connected to the portion of the first weight portion and the second groove portion surrounding away from the second weight portion, connected to the first frame portion, and constituting the frame portion. The third substrate including the third groove portion for defining the third weight portion constituting the weight portion and connected to the second weight portion, the third frame portion surrounding away from the third weight portion, the beam portion connecting the third weight portion and the third frame portion, the displacement restricting portion extending from the third frame portion and covering the first weight portion, and the flexible portion disposed away from the third weight portion, the beam portion, and the displacement restricting portion, extending from the third frame portion, and covering the first weight portion.

In the acceleration sensor configured above, the second substrate is formed of a silicon oxide film.

In the embodiments described above, it may be configured such that the method of producing the acceleration sensor comprises the steps of:

preparing the laminated substrate formed of the first substrate, the second substrate formed on the first substrate, and the third substrate formed on the second substrate;

forming the first groove portion in the third substrate for defining the third weight portion constituting the weight portion, the third frame portion surrounding away from the first weight portion and constituting the frame portion, the stopper portion disposed away from the weight portion and the frame portion and connected to the third frame portion, in which the stopper portion includes the displacement restricting portion for restricting the displacement of the weight portion and the flexible portion connected to the displacement restricting portion, disposed away from the weight portion, the beam portion, and the frame portion, and covering the weight portion;

forming the second groove portion in the first substrate for defining the first weight portion constituting the weight portion and disposed away from and covering the stopper portion, and the first frame portion constituting the frame portion and surrounding away from the first weight portion; and

removing the second substrate for forming the second frame portion constituting the frame portion and connecting the first frame portion and the third frame portion, and the second weight portion constituting the weight portion and connecting the first weight portion and the third weight portion.

In the method of producing the acceleration sensor configured above, in the step of preparing the laminated substrate, the second substrate is formed of a silicon oxide film.

The disclosure of Japanese Patent Application No. 2008-085736, filed on Mar. 28, 2008, is incorporated in the application.

While the invention has been explained with reference to the specific embodiments of the invention, the explanation is illustrative and the invention is limited only by the appended claims.

What is claimed is:

1. An acceleration sensor, comprising:
a weight portion;
a frame portion disposed around the weight portion and away from the weight portion;
a beam portion connecting the weight portion and the frame portion; and
a stopper portion having a displacement restricting portion for restricting the weight portion from moving upwardly in a vertical direction and a flexible portion connected to the displacement restricting portion and disposed away from the weight portion, the frame portion, and the beam portion.

2. The acceleration sensor according to claim 1, further comprising a connecting portion for connecting the displacement restricting portion and the flexible portion, said connecting portion having a width smaller than that of the beam portion.

3. The acceleration sensor according to claim 1, wherein said stopper portion further includes an opening portion.

4. The acceleration sensor according to claim 1, wherein said displacement restricting portion has an area smaller than that of the flexible portion.

5. An acceleration sensor, comprising:
a weight portion;
a frame portion disposed around the weight portion and away from the weight portion;
a beam portion connecting the weight portion and the frame portion;
a displacement restricting portion for restricting the weight portion from moving upwardly in a vertical direction;
a flexible portion disposed away from the weight portion, the frame portion, and the beam portion for covering the weight portion; and
a connecting portion for connecting the displacement restricting portion and the flexible portion.

6. The acceleration sensor according to claim 5, wherein said connecting portion has a width smaller than that of the beam portion.

7. The acceleration sensor according to claim 5, wherein said displacement restricting portion has an area smaller than that of the flexible portion.

8. An acceleration sensor, comprising:
a laminated substrate including a first substrate, a second substrate formed on the first substrate, and a third substrate formed on the second substrate, said first substrate including a first groove portion for separating a first weight portion constituting a weight portion and a first frame portion surrounding away from the first weight portion and constituting a frame portion, said second substrate including a second groove portion for separating a second weight portion constituting the weight portion and connected to a portion of the first weight portion and a second groove portion surrounding away from the second weight portion, connected to the first frame portion, and constituting the frame portion, said third substrate including a third groove portion for defining a third weight portion constituting the weight portion and connected to the second weight portion, a third frame portion surrounding away from the third weight portion, a beam portion connecting the third weight portion and the third frame portion, a displacement restricting portion extending from the third frame portion and covering the first weight portion, and a flexible portion disposed away from the third weight portion, the third frame portion, and the beam portion, extending from the displacement restricting portion, and covering the first weight portion.

9. The acceleration sensor according to claim 8, wherein said second substrate is formed of a silicon oxide film.

10. The acceleration sensor according to claim 8, wherein said third groove portion extends between the displacement restricting portion and the flexible portion.

11. The acceleration sensor according to claim 8, further comprising an opening portion formed in a connecting portion between the displacement restricting portion and the flexible portion.
